(19) United States
(12) Patent Application Publication
(10) Pub. No.: US 2023/0078363 A1
(43) Pub. Date: Mar. 16, 2023

(54) SYNTHESIS OF AMORPHOUS AND NANOSTRUCTURED LUTETIUM BORATE HEXAHYDRATE AND METHOD FOR PREPARING STABLE COLLOIDAL DISPERSIONS

(71) Applicant: VERTRATECH KIMYA SANAYI VE TICARET LIMITED SIRKETI, Bigadiç, Balikesir (TR)

(72) Inventor: Berna BÜLBÜL, Karesi, Balikesir (TR)

(21) Appl. No.: 17/906,816

(22) PCT Filed: Mar. 29, 2020
(86) PCT No.: PCT/TR2020/050250

§ 371 Date: Sep. 20, 2022

(30) Foreign Application Priority Data
Mar. 23, 2020 (TR) 2020/04482

(51) Int. Cl. C01B 35/12

(52) U.S. Cl. CPC C01B 35/127; B82Y 30/00

(57) ABSTRACT

The invention relates to a method for the synthesis of amorphous and nanostructured lutetium borate hexahydrate and a method for the preparation of stable colloidal dispersions with obtained lutetium borate hexahydrate having a hydrodynamic size below 150 nm, so as to be used in the field of material, medicine, textile and defense.

### TECHNICAL FIELD

The invention relates to a method for the synthesis of amorphous and nanostructured lutetium borate hexahydrate and a method for the preparation of stable colloidal dispersions with obtained lutetium borate hexahydrate having a hydrodynamic size below 150 nm, so as to be used in the field of material, medicine, textile and defense.

### STATE OF THE ART

Lutetium (Lu) which is the last of the lanthanide serial elements has an atomic number of 71, atomic weight of 174,96 g/mol and a density of 9,84 g/cm³. Lutetium which is subjected to the neutron activation commercially is widely used as a pure beta-emitter in the state of the art. While lutetium aluminum garnet can be used as a lens material in lithography, Lutetium-176 from the radioactive isotopes is used to determine the age of the meteors. It acts as a catalyst in some alloys and various chemicals, and also it is a good catalyst for separating the hydrocarbons in oil refineries.

Lu-177 isotope is used in the treatment of radionuclide treatment in neuro-endocrine tumors in the nuclear medicine. Its use as a radionuclide in neuro-endocrine tumor therapy and bone pain palliation becomes increasingly widespread. It is also widely used in the treatment of prostate cancer. The applications of this isotope in the field of medicine become increasingly widespread.

Lutetium tantalite is an ideal material for the X-ray phosphors as the most dense and stable white material. On the other hand lutetium oxiorthosilicate is used in the detectors in the positron emission tomography. This detector is a medical scanning device which gives a three dimensional view of the cellular activities of the body. Memory devices, hard discs, tomography devices, LED bulbs, oil refineries, drilling operations are some of the other important usage fields of the lutetium compounds.

Rare earth orthoborate compounds (LnBO3 Ln: Y, La, Nd, Pr, Eu, Sm, Gd, Ho, Tb, Er, Dy, Yb, Tm, Lu) have many excellent properties such as high ultraviolet transparency, large electronic band gap, chemical and physical stability, extraordinary optical damage threshold. They are suitable materials with such features for gas discharge panels, plasma display panels, fluorescent lamps, x-ray and gamma ray detectors, nonlinear optical devices, scintillators, neutron detectors and medical monitoring. In addition, borate compounds which are mixed with rare earth elements are very effective compounds in converting the high energy radiation into visible light efficiency. Particularly lutetium borate compounds containing rare earth are good scintillator materials due to their high density.

Lutetium borate compounds are ionic structured compounds by the combination of the Lutetium cations with +3 oxidation steps and negative charged borate anions. Lutetium borate compound which is most well-known borate compound in literature has LuBO₃ chemical formula. When other rare earth metals are added into this compound, the synthesized Ln:LuBO₃ compounds are also present. In the synthesis of the crystal structured LuBO₃ and Ln:LuBO₃ compounds with or without additives, there are three main synthesis methods used in the literature till now for the synthesis of the compounds. These are sol gel method, conventional solid-state method and hydrothermal method. But none of these methods are suitable for the production of these compounds on a fabricated scale. The reason for this is that all of these synthesis methods have high cost and high energy consumption.

The amorphous and nanostructured materials have the ability to be processed more easily, to be converted into films and to form ideal composites with polymers compared to the crystalline structured ones. Particularly this compound will have widespread application areas in many fields as a result of preparing stable colloidal dispersions of the amorphous, nanostructured and equidimensional lutetium borates with optical feature in water. The main fields are textile, material and defense industries. Interaction of the polymers in the presence of the surfactants with these stable colloidal dispersions will allow the formation of ideal composites which have many superior features in these application areas. In addition to this, there is no information in the literature in terms of the roles of these materials in the biological system. The synthesis of the amorphous, smooth and round-like fragment formed and optical lutetium borate compounds with particle size below 100 nm is very important regarding the awareness of the roles of these compounds in the biological system.

As a result, due to the abovementioned disadvantages, deficiencies, there is a requirement to make an innovation in the relevant technical field.

### AIM OF THE INVENTION

The present invention is related to the synthesis of amorphous and nanostructured lutetium borate hexahydrate and method for the preparation of stable colloidal dispersions which fulfill the abovementioned requirements eliminate all disadvantages and bring some additional advantages.

The main aim of the invention is the synthesis of amorphous and nanostructured lutetium borate hexahydrate and the preparation of stable colloidal dispersions with obtained lutetium borate hexahydrate having a hydrodynamic size below 150 nm, so as to be used in the field of material, medicine, textile and defense.

An aim of the invention is to allow the formation of ideal composites which have many superior features in these application areas with the interaction of the polymers in the presence of the surfactants with these stable colloidal dispersion will allow the formation of ideal composites which have many superior features in these application areas. Another aim of the invention is to synthesize the amorphous, smooth and round-like fragment formed and optical lutetium borate compounds with particle size below 150 nm.

Another aim of the invention is to synthesize the amorphous, nanostructured and new Lu₂O₃B₂O₃·6H₂O (lutetium boratehexahydrate) compound by a common precipitation method which is suitable for fabrication, easy and cost effective.

In order to fulfill the above mentioned aims the invention is a method for the synthesis of amorphous and nanostructured lutetium borate hexahydrate so as to be used in the field of material, medicine, textile and defense, characterized in that, it comprises the following process steps;

a) preparing lutetium nitrate solution by dissolving the lutetium nitrate compound in water,

b) adding sodium hydroxide or sodium carbonate and boric acid or borate solid into the water in a separate container, mixing the same until a transparent colored solution is obtained and obtaining borate solution,

c) dissolving biocompatible and water-soluble surfactants in the water, preparing a solution at the saturation limit,

d) mixing the prepared surfactant solution with lutetium nitrate solution prepared in the process step a such that metal nitrate-surfactant (YAM) ratio is 1:1, 1:2, 1:3, 1:4 or 1:5, obtaining lutetium nitrate-YAM solution,

e) adding the lutetium nitrate solution prepared in the process step a or the metal nitrate-YAM solution prepared in the process step d borate solution is added in the reaction flask, adding the borate solution prepared in the process step b under a mechanical mixer (2000 rpm) until the pH is 7 and mixing the obtained mixture during half an hour at a constant speed.

f) washing the solid part which is obtained from separating the precipitated solid part from the liquid part with the help of the centrifuge with plenty of pure water so as to eliminate impurities and drying or heating the same at 70° C. for 24 hours.

In order to fulfill the aims of the invention, a method for the preparation of stable colloidal dispersions with obtained lutetium borate hexahydrate having a hydrodynamic size below 150 nm, characterized in that, it comprises the following process steps;

a) dispersing the lutetium borate hexahydrate compound in pure water with the help of blender before it is dried,

b) processing the obtained heterogeneous mixture until the stable colloidal solution is obtained with the help of the centrifuge, homogenizer or nanofluidizer or

c) dissolving biocompatible and water-soluble surfactants in the water, preparing a solution at the saturation limit and obtaining lutetium borate hexahydrate-YAM solution by mixing the prepared surfactant with the lutetium borate hexahydrate solution prepared in the process step a such that lutetium borate hexahydrate-surfactant (YAM) ratio is 1:1, 1:2, 1:3, 1:4 or 1:5,

d) distilling the concentration of obtained solution such that it is within the 400-500 ppm range,

e) processing the obtained heterogeneous mixture until a stable colloidal solution is obtained with the help of the centrifuge, homogenizer or nanofluidizer.

The structural and characteristic features of the present invention will be understood clearly by the following detailed description and therefore the evaluation shall be made by taking the detailed description into consideration.

### FIGURES CLARIFYING THE INVENTION

FIG. 1: is a XRD graph of Lu₂O₃B₂O₃6H₂O compound

FIG. 2: is a FTIR spectrum graph of Lu₂O₃B₂O₃6H₂O compound

FIG. 3: is a TG/DTG graph of Lu₂O₃B₂O₃6H₂O compound

FIG. 4: is a size distribution graph of Lu₂O₃B₂O₃6H₂O compound

FIG. 5: is a surface potential graph of Lu₂O₃B₂O₃6H₂O nanoparticles in the pure water

### DETAILED DESCRIPTION OF THE INVENTION

In this detailed description, the inventive method for the synthesis of amorphous and nanostructured lutetium borate hexahydrate and method for preparing stable colloidal dispersions is described by means of examples only for clarifying the subject matter such that no limiting effect is created.

The invention relates to 6 different methods for the synthesis of amorphous and nanostructured lutetium borate hexahydrate (Lu₂O₃B₂O₃·6H₂O) compounds by means of a common precipitation method which is suitable for fabrication, easy and cost effective and a method for the preparation of stable colloidal dispersions with obtained lutetium borate hexahydrate compounds having a hydrodynamic size below 150 nm, so as to be used in the field of material, medicine, textile and defense.

Synthesis Methods

A) Synthesis of Amorphous and Nanostructured Lutetium Borate Compounds Without Any Surfactant

1Lu(NO₃)₃XH₂O +3NaOH+6H₃BO₃→Lu₂O₃B₂O₃6H₂O Synthesis method 1

Lutetium nitrate solution is obtained by dissolving 10 mmol lutetium nitrate compound according to the cytochiometric ratio in the equation shown above within 200 ml water. Provided that cytochiometric ratio of 1:2 is kept constant, 30 mmol sodium hydroxide is dissolved in 100 ml water in a separate container and 60 mmol boric acid is added on it. Borate solution is achieved by means of mixing until a transparent colored solution is achieved.

Borate solution is added to the lutetium nitrate placed in the reaction flask under a mechanical mixer (2000 rpm) until the pH is 7. When the pH reaches 7, the addition of borate solution is terminated and the obtained mixture is continued to be mixed during half an hour at a constant speed. At the end of the mixing process, a milk-like mixture is obtained. The precipitated solid part is separated from the liquid part with the help of centrifuge. Obtained solid part is washed with plenty of pure water so as to eliminate impurities and is heated at 70° C. for 24 hours.

1Lu(NO₃)₃XH₂O+3/2Na₂CO₃6H₃BO₃→LuO₃B₂O₃6H₂O Synthesis method 2

Lutetium nitrate solution is obtained by dissolving 10 mmol lutetium nitrate compound according to the cytochiometric ratio in the equation shown above within 200 ml water. Provided that the cytochiometric ratio of 1:4 is kept constant, 15 mmol of sodium carbonate is dissolved in 100 ml water in a separate container and 60 mmol of boric acid is added on it. Borate solution is achieved by means of mixing until a transparent colored solution is achieved.

Borate solution is added to the lutetium nitrate solution placed in the reaction flask under a mechanical mixer (2000 rpm) until the pH is 7. When the pH reaches 7, the addition of borate solution is terminated and the obtained mixture is continued to be mixed during half an hour at a constant speed. At the end of the mixing process, a milk-like mixture is obtained. The precipitated solid part is separated from the liquid part with the help of centrifuge. Obtained solid part is washed with plenty of pure water so as to eliminate impurities and is heated at 70° C. for 24 hours.

1Lu(NO₃)₃XH₂O+3/2Na₂B₄O₇·10H₂O→Lu₂O₃B₂O₃6H₂O Synthesis method 3

Lutetium nitrate solution is obtained by dissolving 10 mmol lutetium nitrate compound according to the cytochiometric ratio in the equation shown above within 20 ml water. Provided that the cytochiometric ratio shown in the above equation is kept constant, 15 mmol borate solid is added in 280 ml water in a separate container. Borate solution is achieved by means of mixing until a transparent colored solution is achieved.

Borate solution is added to the lutetium nitrate placed in the reaction flask under a mechanical mixer (2000 rpm) until the pH is 7. When the pH reaches 7, the addition of borate solution is terminated and the obtained mixture is continued to be mixed during half an hour at a constant speed. At the end of the mixing process, a milk-like mixture is obtained. The precipitated solid part is separated from the liquid part with the help of centrifuge. Obtained solid part is washed with plenty of pure water so as to eliminate impurities and is heated at 70° C. for 24 hours.

B) Synthesis of Amorphous and Nanostructured Lutetium Borate Compounds in the Presence of Surfactant

1Lu(NO₃)₃XH₂O+(YAM)+3NaOH+6H₃BO₃→Lu₂O₃B₂O₃6H₂O Synthesis method 4

Lutetium nitrate solution is obtained by dissolving 10 mmol lutetium nitrate compound according to the cytochiometric ratio in the equation shown above within 200 ml water. Provided that the cytochiometric ratio of 1:2 is kept constant, 30 mmol of sodium hydroxide is dissolved in 100 ml water in a separate container and 60 mmol of boric acid is added on it. Borate solution is achieved by means of mixing until a transparent colored solution is achieved.

Biocompatible and water-soluble surfactants are added into the water in an amount of mol which is appropriate to the equation above and a solution at the saturation limit is prepared. The prepared surfactant solution is mixed with lutetium nitrate solution for half an hour and lutetium nitrate YAM solution is achieved such that metal nitrate-surfactant (YAM) ratio is 1:1, 1:2, 1:3, 1:4 or 1:5.

Borate solution is added to the lutetium nitrate-YAM solution placed in the reaction flask under a mechanical mixer (2000 rpm) until the pH is 7. When the pH reaches 7, the addition of borate solution is terminated and the obtained mixture is continued to be mixed during half an hour at a constant speed. At the end of the mixing process, a milk-like mixture is obtained. The precipitated solid part is separated from the liquid part with the help of centrifuge. Obtained solid part is washed with plenty of pure water so as to eliminate impurities and is heated at 70° C. for 24 hours.

1Lu(NO₃)₃XH₂O+(YAM)+3/2Na₂CO₃+6H₃BO₃→Lu₂O₃B₂O₃6H₂O Synthesis method 5

Lutetium nitrate solution is obtained by dissolving 10 mmol lutetium nitrate compound according to the cytochiometric ratio in the equation shown above within 200 ml water. Provided that the cytochiometric ratio of 1:4 is kept constant, 15 mmol of sodium carbonate is dissolved in 100 ml water in a separate container and 60 mmol of boric acid is added on it. Borate solution is achieved by means of mixing until a transparent colored solution is achieved.

Biocompatible and water-soluble surfactants are added into the water in an amount of mol which is appropriate to the equation above and a solution at the saturation limit is prepared. The prepared surfactant solution is mixed with lutetium nitrate solution for half an hour and lutetium nitrate YAM solution is achieved such that metal nitrate-surfactant (YAM) ratio is 1:1, 1:2, 1:3, 1:4 or 1:5.

Borate solution is added to the lutetium nitrate-YAM solution placed in the reaction flask under a mechanical mixer (2000 rpm) until the pH is 7. When the pH reaches 7, the addition of borate solution is terminated and the obtained mixture is continued to be mixed during half an hour at a constant speed. At the end of the mixing process, a milk-like mixture is obtained.

The precipitated solid part is separated from the liquid part with the help of centrifuge. Obtained solid part is washed with plenty of pure water so as to eliminate impurities and is heated at 70° C. for 24 hours.

1Lu(NO₃)₃XH₂O+(YAM)+3/2Na₂B₄O₇·10H₂O→Lu₂O₃B₂O₃6H₂O Synthesis method 6

Lutetium nitrate solution is obtained by dissolving 10 mmol lutetium nitrate compound according to the cytochiometric ratio in the equation shown above within 20 ml water. Provided that the cytochiometric ratio shown in the above equation is kept constant, 15 mmol of borate solid is added in 280 ml water in a separate container. Borate solution is achieved by means of mixing until a transparent colored solution is achieved.

Biocompatible and water-soluble surfactants are added into the water in an appropriate amount of mol determined above and a solution at the saturation limit is prepared. The prepared surfactant solution is mixed with lutetium nitrate solution for half an hour and lutetium nitrate YAM solution is achieved such that metal nitrate-surfactant (YAM) ratio is 1:1, 1:2, 1:3, 1:4 or 1:5.

Borate solution is added to the lutetium nitrate-YAM solution placed in the reaction flask under a mechanical mixer (2000 rpm) until the pH is 7. When the pH reaches 7, the addition of borate solution is terminated and the obtained mixture is continued to be mixed during half an hour at a constant speed. At the end of the mixing process, a milk-like mixture is obtained. The precipitated solid part is separated from the liquid part with the help of centrifuge. Obtained solid part is washed with plenty of pure water so as to eliminate impurities and is heated at 70° C. for 24 hours.

In the methods for synthesis of the amorphous and nanostructured lutetium borate compounds in the presence of the surfactant, water soluble forms of the surfactants can be used, polyethylene glycol (PEG), chitosan, hyaluronic acid (HA), F-68, F-127, acrylic acid, ethyl cellulose, polyvinyl pyrrolydine or triton x-100 can be used as a surfactant.

C) Method for Preparing Stable Colloidal Dispersions

The white colored amorphous and nanostructured lutetium borate hexahydrate compound (2,5-3 gr) which is obtained by any of the six different synthesis methods above is dispersed in 6 liters of pure water with the help of blender before it is dried. Obtained heterogeneous mixture is processed until the stable colloidal solution is obtained by means of the centrifuge, homogenizer or nanofluidizer. The concentration of the obtained stable colloidal solutions is between 400-500 ppm.

D) Method for Preparing Stable Colloidal Dispersions in The Presence of Surfactant

The white colored amorphous and nanostructured lutetium borate hexahydrate compound (2,5-3 gr) which is obtained by any of the six different synthesis methods above is dispersed in 200 ml of pure water with the help of blender before it is dried.

Biocompatible and water-soluble surfactants are added into the water in an appropriate amount of mol determined above and a solution at the saturation limit is prepared. The prepared surfactant solution is mixed with lutetium borate hexahydrate solution for half two hours and lutetium borate hexahydrate-YAM solution is achieved such that lutetium borate hexahydrate-surfactant (YAM) ratio is 1:1, 1:2, 1:3, 1:4 or 1:5. The concentration of obtained solution is distilled with water so as to be within the 400-500 ppm range. Obtained heterogeneous mixture is processed until a stable colloidal solution is obtained with the help of the centrifuge, homogenizer or nanofluidizer. In the method for preparing stable colloidal dispersions in the presence of surfactant, the same YAM is used in preparing the colloidal dispersion whatever YAM is used in the synthesis of the lutetium borate hexahydrate compound prepared with YAM. In the same method, the solution can be heated at temperatures below 100° C. according to the surfactant used when it is considered that it is necessary to prepare lutetium borate hexahydrate-YAM solution.

The methods for the synthesis of the inventive amorphous and nanostructured Lu₂O₃B₂O₃6H₂O compound with and without YAM can also be used in obtaining single- metal and double-metal amorphous and nanostructured borate compounds of other lanthanide series elements (Y, La, Pr, Nd, Sm, Eu, Gd, Tb, Dy, Ho, Er, Tm, Yb). The borate structured compounds to be synthesized are given below.

Y₂O₃B₂O₃6H₂O, La₂O₃B₂O₃6H₂O, Pr₂O₃B₂O₃6H₂O, Nd₂O₃B₂O₃6H₂O, Sm₂O₃B₂O₃6H₂O, Eu₂O₃B₂O₃6H₂O, Gd₂O₃B₂O₃6H₂O, Tb₂O₃B₂O₃6H₂O, Dy₂O₃B₂O₃6H₂O, Ho₂O₃B₂O₃6H₂O, Er₂O₃B₂O₃6H₂O, Tm₂O₃B₂O₃6H₂O, Yb₂O₃B₂O₃6H₂O, DyErO₃B₂O₃6H₂O, LuErO₃B₂O₃6H₂O, LuDyO₃B₂O₃6H₂O etc.

The lead borate hydrate, barium borate hydrate and strontium borate hydrate compounds having amorphous and nanostructured MOB₂O₃·1H₂O (M: Pb, Ba, Sr) formula can also be synthesized by using six different synthesis methods described above. The reaction equations and cytochiometric ratios to be used in the preparation of these compounds are as follows.

M(NO₃)₂+2NaOH+4H₃BO3→MOB₂O₃1H₂O

M(NO₃)₂+Na₂CO₃+4H₃BO₃→MOB₂O₃1H₂O

M(NO₃)₂+Na₂B₄O₇·10H₂O→MOB₂O₃1H₂O

### Example 1

1Lu(NO₃)₃XH₂O+2(PEG 2000)+3NaOH+6H₃BO₃→Lu₂O₃B₂O₃6H₂O

The ratio of the metal elements in the chemical formula of the white powder product which is obtained as a result of the reaction realized with the synthesis method 4 is determined by means of ICP-MS analysis method. As a result of the calculations made, lu/B ratio in the chemical formula is determined as 1,03.

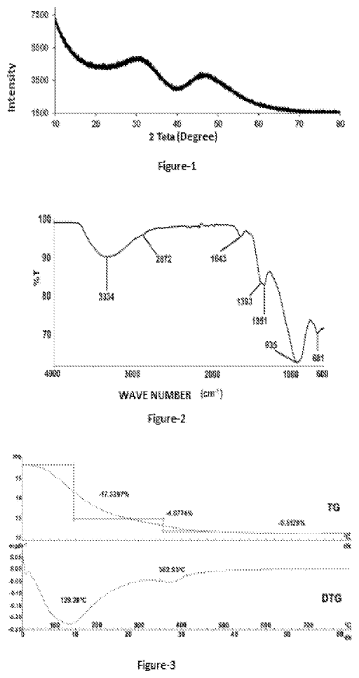

XRD analysis of the obtained product was realized, and XRD graph of Lu₂O₃B₂O₃6H₂O compound is given in FIG. 1. As it can be understood from the graph, obtained lutetium borate has an amorphous feature and does not have any crystal structure.

FIG. 2: is a FTIR spectrum graph of Lu₂O₃B₂O₃6H₂O compound. There are strong vibration bands in the 1393 cm⁻¹ and 1351 cm⁻¹ ([BO₃] asymmetrical stretching) and 935 cm⁻¹ ([BO₃] symmetrical stretching) wave number region in the FTIR spectrum. In addition to this, the spectrum comprises a week vibration band in the 681 cm⁻¹ ([BO₃] out of plane linkage) wave number. These vibration bands powerfully support that borate type in the Lu₂O₃B₂O₃6H₂O compound structure is a plane triangle [BO₃] group. The broad and powerful vibration band seen in the FTIR spectrum at 3334 cm⁻¹ corresponds to the symmetrical stretching vibrations of [OH] groups, the weak vibration band seen at 1643 cm⁻¹ corresponds to the in-plane bending vibrations of [HOH] groups in the crystal water. The weak and broad vibration band in the 2872 cm-1 wave number region is the bending vibration of the [HCH] group in PEG-2000 compound. This result shows that PEG-2000 molecules settled in the medium are very slightly attached to the surface of the lutetium borate hexahydrate nanoparticles so as to obtain equidimenisonal particles.

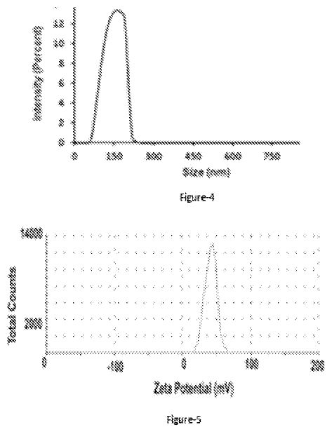

FIG. 3: is a TG/DTG graph of Lu₂O₃B₂O₃6H₂O compound. In the TG/DTG curve, two endothermic peaks are observed where there is loss of mass. The first 17,3297% mass loss occurs between 303 K and 523 K. The calculations made have revealed that this mass loss corresponds to 6 moles of water which diverges from the structure. The second 4,0774% mass loss occurs between 523 K and 693 K. This temperature interval corresponds to the decomposition temperature interval of PEG-2000 molecules used as surfactant.

This result shows that, when they are washes with a plenty of water, most of PEG-2000 molecules diverge from the medium, in addition to this only a small part of them can attach on the surface of the nano particles.

When the particle form and size of the lutetium borate hexahydrate compound is examined using SEM and TEM photos, it is found that its particle shape is partially spherical. In TEM photos, the sizes of 310 particles are measured one by one by using Image J program and the average particle size and standard deviation is calculated as 20 nm±5 nm.

FIG. 4: is a size distribution graph of Lu₂O₃B₂O₃6H₂O compound The zeta potential and size distribution of the prepared stable dispersion of the Lu₂O₃B₂O₃6H₂O nanoparticles (approximately 500 ppm) prepared in water without using surfactant (YAM9 is measured by using dynamic light scattering method (with NanoZS). The average hydrodynamic diameter of the nano particles of the lutetium borate hexahydrate is seen to be 150 nm (PDI:0.153) from the size distribution graph in FIG. 4.

FIG. 5: is a surface potential graph of Lu₂O₃B₂O₃6H₂O nanoparticles in the pure water. The surface potential of Lu₂O₃B₂O₃6H₂O nanoparticles in the pure water is determined as +45,2±7,8 mV. The positive charge shows that the outer sections of the nano particles comprise Lu+3 ions and the borates are more internal. This high positive value also means that very stable dispersions of nano particles can be prepared. If high zeta potential value (positive or negative) is typically more than 30 mV, then the prepared colloidal system is stable. It is observed that prepared aqueous colloidal dispersions do not precipitate for more than 3 months.

1. Method for the synthesis of amorphous and nanostructured lutetium borate hexahydrate so as to be used in the field of material, medicine, textile and defense, characterized in that, it comprises the following process steps;
a. preparing lutetium nitrate solution by dissolving the lutetium nitrate compound in water,
b. adding sodium hydroxide or sodium carbonate and boric acid or borate solid into the water in a separate container, mixing the same until a transparent colored solution is obtained and obtaining borate solution,
c. dissolving biocompatible and water-soluble surfactants in the water, preparing a solution at the saturation limit and obtaining lutetium nitrate-YAM solution by mixing the prepared surfactant with the lutetium nitrate solution prepared in the process step a such that metal nitrate-surfactant (YAM) ratio is 1:1, 1:2, 1:3, 1:4 or 1:5,
d. adding the lutetium nitrate solution prepared in the process step a or the metal nitrate-YAM solution prepared in the process step c in the reaction flask, adding the borate solution prepared in the process step b under a mechanical mixer (2000 rpm) until the pH is 7 and mixing the obtained mixture during half an hour at a constant speed,
e. washing the solid part which is obtained from separating the precipitated solid part from the liquid part with the help of the centrifuge with plenty of pure water so as to eliminate impurities and drying or heating the same at 70° C. for 24 hours.

2. A method according to claim 1, characterized in that; said borate solid in the process step b has Na₂B₄O₇·10H₂O closed formula.

3. Method according to claim 1, characterized in that; said surfactant in the process step c is in the water soluble forms of polyethylene glycol (PEG), chitosan, hyaluronic acid (HA), F-68, F-127, acrylic acid, ethyl cellulose, polyvinyl pyrrolydine or triton x-100.

4. The product obtained by said method according to any of the preceding claims is the lutetium borate hexahydrate compound having Lu₂O₃B₂O₃6H₂O closed formula.

5. Usage of method according to claim 1-3 in obtaining single-metal and double-metal amorphous and nanostructured borate compounds of the lanthanide series elements.

6. Usage of method according to claim 1-3 in obtaining borate hydrate compounds having amorphous and nano-structured MOB₂O₃·1H₂O closed formula. (M: Pb, Ba, Sr)

7. Method for the preparation of stable colloidal dispersions of lutetium borate hexahydrate having a hydrodynamic size below 150 nm according to claim 4, characterized in that, it comprises the following process steps;
a. dispersing the lutetium borate hexahydrate compound in pure water with the help of blender before it is dried,
b. processing the obtained heterogeneous mixture until the stable colloidal solution is obtained with the help of the centrifuge, homogenizer or nanofluidizer or
c. dissolving biocompatible and water-soluble surfactants in the water, preparing a solution at the saturation limit and obtaining lutetium borate hexahydrate-YAM solution by mixing the prepared surfactant with the lutetium borate hexahydrate solution prepared in the process step a such that lutetium borate hexahydrate-surfactant (YAM) ratio is 1:1, 1:2, 1:3, 1:4 or 1:5,
d. distilling the concentration of obtained solution such that it is within the 400-500 ppm range,
e. processing the obtained heterogeneous mixture until a stable colloidal solution is obtained with the help of the centrifuge, homogenizer or nanofluidizer.

8. Method according to claim 7, characterized in that; said surfactant is in the water soluble forms of polyethylene glycol (PEG), chitosan, hyaluronic acid (HA), F-68, F-127, acrylic acid, ethyl cellulose, polyvinyl pyrrolydine or triton x-100.
